(19) United States
(12) Patent Application Publication
(10) Pub. No.: US 2020/0195446 A1
(43) Pub. Date: Jun. 18, 2020

(54) SYSTEM AND METHOD FOR ENSURING FORWARD & BACKWARD SECRECY USING PHYSICALLY UNCLONABLE FUNCTIONS

(71) Applicant: SRI International, Menlo Park, CA (US)

(72) Inventors: Tancrede Lepoint, Jersey City, NJ (US); Neil Hanley, Belfast (GB)

(21) Appl. No.: 16/223,202

(22) Filed: Dec. 18, 2018

(51) Int. Cl. H04L 9/32; H04L 9/08; H04L 29/06

(52) U.S. Cl. CPC H04L 9/3278; H04L 9/0841; H04L 9/0869; H04L 63/068; H04L 63/0442

(57) ABSTRACT

Methods and systems for ensuring forward and backward secrecy in an encrypted communication protocol are provided herein. In some embodiments, a method for ensuring forward and backward secrecy in an encrypted communication protocol includes extracting, from a first device, a unique physically unclonable function (PUF) value of the first device based on structural properties of the first device, creating a PUF key pair including a first public key and a first private key that are generated based on the PUF value, deriving a first session key using the PUF key pair, deleting the first public key and the first private key, and sending a first encrypted communication to a second device using the derived session key.

### FIELD

Embodiments of the present invention generally relate to an encrypted communication protocol, and more particularly, to methods and systems method for ensuring forward and backward secrecy using physically unclonable functions (PUF).

### BACKGROUND

Security is a big concern in adopting Internet of things (IoT) technology. In particular, as the Internet of things spreads widely, cyber-attacks have become an increasingly prevalent threat. The current IoT space comes with numerous security vulnerabilities. This allows attackers to easily intercept data to collect PII (Personally Identifiable Information), user credentials can be stolen at login or malware can be injected into newly updated firmware.

A common encryption used in securing communications between devices, including IoT devices, is through the use of public-key cryptography. Public-key cryptography, or asymmetric cryptography, is any cryptographic system that uses pairs of keys: public keys which may be disseminated widely, and private keys which are known only to the owner. This accomplishes two functions: authentication, where the public key verifies that a holder of the paired private key sent the message, and encryption, where only the paired private key holder can decrypt the message encrypted with the public key.

In a public key encryption system, any person can encrypt a message using the receiver's public key. That encrypted message can only be decrypted with the receiver's private key. To be practical, the generation of a public and private key-pair must be computationally economical. The strength of a public key cryptography system relies on the computational effort (work factor in cryptography) required to find the private key from its paired public key. Effective security only requires keeping the private key private; the public key can be openly distributed without compromising security.

Even with encryption, embedded devices can be subject to a broad range of persistent and advanced attacks, and if keys can be read out of a system this can lead to cloning or forging of data sent from the device. If the private key is compromised, a device can be cloned and forward and backward secrecy of data communications is lost, allowing past and future messages respectively to be recovered. Attempts have been made to ensure forward secrecy by creating new public/private key pairs for every communication using a system like Diffie-Hellman to negotiate a key. If a private key is compromised, only the specific session it protected will be revealed to an attacker. However, if the generation of the private key can be replicated remotely, then it could compromise forward and backward secrecy of data communications.

Therefore, a need exists in the art for improved method and system for ensuring forward and backward secrecy in data communications.

### SUMMARY

Methods and systems for ensuring forward and backward secrecy in an encrypted communication protocol are provided herein. In some embodiments, a method for ensuring forward and backward secrecy in an encrypted communication protocol includes extracting, from a first device, a unique physically unclonable function (PUF) value of the first device based on structural properties of the first device, creating a PUF key pair including a first public key and a first private key that are generated based on the PUF value, deriving a first session key using the PUF key pair, deleting the first public key and the first private key; and sending a first encrypted communication to a second device using the derived session key.

In some embodiments, a system for ensuring forward and backward secrecy in an encrypted communication protocol includes a first device having a unique physically unclonable function (PUF) value based on structural properties of the first device, a public key pair generator configured to create a PUF key pair including a public key and a secret key that are generated based on the PUF value, a session key generator configured to derive a first session key using the PUF key pair and PUF value, and a secure communication module configured to send a first encrypted communication to a second device using the derived session key.

In some embodiments, a non-transitory computer-readable storage device having stored thereon a plurality of instructions, the plurality of instructions including instructions which, when executed by a processor, cause the processor to perform a method for ensuring forward and backward secrecy in an encrypted communication protocol which includes extracting, from a first device, a unique physically unclonable function (PUF) value of the first device based on structural properties of the first device, creating a PUF key pair including a first public key and a first private key that are generated based on the PUF value, deriving a first session key using the PUF key pair, deleting the first public key and the first private key; and sending a first encrypted communication to a second device using the derived session key.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts categories of PUFs that can be used in accordance with an embodiment of the present principles.

FIG. 2 depicts a high-level block diagram of embodiments of an encrypted communication system that is configured to ensure forward and backward secrecy using PUF in accordance with an embodiment of the present principles.

FIGS. 3A-3B flow diagrams of methods for ensuring forward and backward secrecy using PUF in accordance with an embodiment of the present principles.

FIG. 4 depicts a signal diagram of methods and systems for ensuring forward and backward secrecy using PUF in accordance with an embodiment of the present principles.

FIG. 5 is a depiction of a computer system that can be utilized in various embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to an encrypted communication protocol, and more particularly, to methods and systems method for ensuring forward and backward secrecy using physically unclonable functions (PUFs). In embodiments described herein, every device computes a private/public key pair that is derived directly from their PUF response. These keys are then integrated into every ephemeral key update “ratchet” when deriving message keys. This advantageously ensures that the shared ephemeral message encryption keys can only be generated on the valid physical devices which are communicating, preventing anybody who has access to the long-term secret keys from reading messages or performing a man-in-the-middle (MITM) attack. As such, embodiments of the present invention, provide forward and backward secrecy without requiring the use of a trusted third party (TTP) which adds additional overhead, cost, and security issues.

Forward secrecy ensures that the leakage of secret keys doesn't affect the secrecy of past communications, therefore if an adversary records all encrypted data a future key leak won't allow the decryption of said data. Backward secrecy ensures that the leakage of a session key does not affect the secrecy of future communications.

Forward secrecy is provided by any public-key system that generates non-deterministic session keys for message encryption and signing, for example Diffie-Hellman (DH) based key exchanges can be used. It is available as an optional feature in a number of protocols and libraries such as SSH, IPSec and TLS for example, as well a double ratchet algorithm as part of the Signal protocol. Forward secrecy is estimated that it adds a computational overhead of 15% to OpenSSL.

PUFs are a cryptographic construction which look to create a unique unclonable identifier for electronic devices. The idea is to take advantage of natural variation in the silicon manufacturing process to create a circuit that is unique to that physical device itself (i.e., a “digital fingerprint”). This subsequently opens up a large number of higher-level operations such as secure memoryless key storage, binding certificates to devices, or lightweight challenge-response protocols.

Rather than embodying a single cryptographic key, PUFs implement challenge-response authentication to evaluate this microstructure. When a physical stimulus is applied to the structure, it reacts in an unpredictable (but repeatable) way due to the complex interaction of the stimulus with the physical microstructure of the device. This exact microstructure depends on physical factors introduced during manufacture which are unpredictable. The applied stimulus is called the challenge, and the reaction of the PUF is called the response.

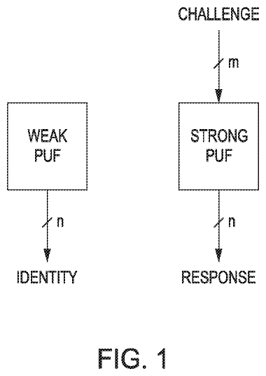

PUFs can be broadly split up into two categories: Weak-PUF (W-PUF) and Strong-PUF (S-PUF) as shown in FIG. 1. W-PUFs contain a small challenge-response space, or no challenge-response in some embodiments, and are more suitable for identity generation in conjunction with some error correction, while S-PUFs generate a unique response to different challenges and are more useful for lightweight authentication protocols. A specific challenge and its corresponding response together form a challenge-response pair or CRP. The device's identity is established by the properties of the microstructure itself. As this structure is not directly revealed by the challenge-response mechanism, it can be used in different constructions to that of a W-PUF.

PUFs can be implemented with a very small hardware investment. Unlike a ROM containing a table of responses to all possible challenges, which would require hardware exponential in the number of challenge bits, a PUF can be constructed in hardware proportional to the number of challenge and response bits. In some cases, PUFs can be built from existing hardware with the right properties. PUFs are well suited for IoT scenarios, providing an alternative to costly secure non-volatile memory (NVM) or Trusted Platform Module (TPM) with a circuit design that requires no extra manufacturing process, as well as providing for lightweight mutual authentication without computationally costly public key algorithms.

Unclonability means that each PUF device has a unique and unpredictable way of mapping challenges to responses, even if it was manufactured with the same process as a similar device, and it is infeasible to construct a PUF with the same challenge-response behavior as another given PUF because exact control over the manufacturing process is infeasible.

The use of PUFs in public key encryption algorithms as described herein advantageously thwarts numerous adversarial models that attempt to compromise security of the system. For example, in an “active eavesdropper” model, the adversary E can intercept and modify all messages between all parties. The protocol remains secure against such an attacker as any message modification will cause the verification stages to fail. Any introduction of a PUF would not weaken this property. In a “misappropriated key” scenario, adversary E is assumed to obtain all of the keys at a certain point in time belonging to device A (the keys could equally belong to device B who is in communication with A), e.g. via some memory leak or malicious process running on the device. Typically, if such keys were compromised, this would allow E to read future messages from both devices A and B, as well as perform a MITM attack by impersonating device A to device B. However, by deriving keys each time using PUFs and deleting the keys after each use as described below, forward and backward secrecy is preserved. It is assumed that any PUF outputs are not compromised here as they are not stored in memory but in the fabric of the device itself.

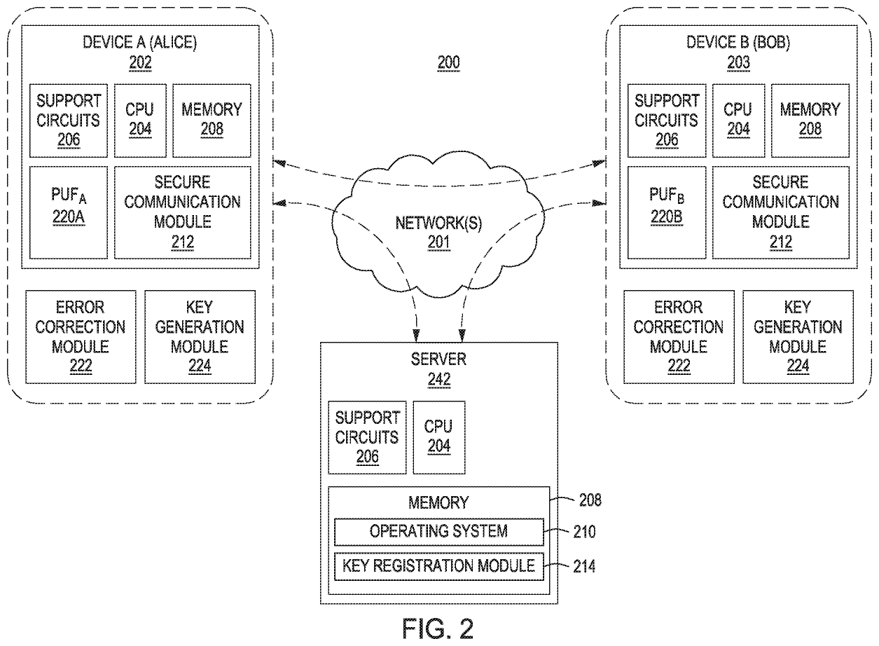

Various embodiments for ensuring forward and backward secrecy using PUFs are now described in detail with respect to FIGS. 2-5. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to visual concepts, such teachings should not be considered limiting.

FIG. 2 depicts a high-level block diagram of embodiments of an encrypted communication system 200 that is configured to ensure forward and backward secrecy using PUF. The system 200 comprises multiple devices, such as Device A 202 (ALICE) and Device B 204 (BOB), and a server 206 all communicatively coupled via networks/cloud 201. In some embodiments, user devices 202 and 204 may be IoT devices. In other embodiments, user devices 202 and 204 may be any type of computing device that transmit and receive messages from other devices (e.g., node to node communications) where security of future messages is important (e.g., such as computers, personal hand-held devices, cellular phones and other devices that contain sensitive information such as financial information/transaction, blockchain transactions, whistleblower communications, anonymous networks, and the like).

The networks 201 comprise one or more communication systems that connect computers by wire, cable, fiber optic and/or wireless link facilitated by various types of well-known network elements, such as hubs, switches, routers, and the like. The networks 201 may include an Internet Protocol (IP) network or other packet-based communication networks, and may employ various well-known protocols to communicate information amongst the network resources.

Each device 202 and 204 may comprise a Central Processing Unit (CPU) 204, support circuits 206, memory 208, and secure communication module 212. The CPU 204 may comprise one or more commercially available microprocessors, microcontrollers, FPGA, etc. that facilitate data processing and storage. The various support circuits 206 facilitate the operation of the CPU 204 and include one or more clock circuits, power supplies, cache, input/output devices and circuits, and the like. The memory 208 comprises at least one of Read Only Memory (ROM), Random Access Memory (RAM), disk drive storage, optical storage, removable storage and/or the like. In some embodiments, the server 242 memory 208 includes an operating system 210 and key registration module 214 for managing registration and distribution of public keys to various devices that want to communicate with each other using public key cryptography. Secure communication module 212 is configured to send/receive encrypted communications to/from other devices.

The operating system (OS) 210 generally manages various computer resources (e.g., network resources, file processors, and/or the like). The operating system 210 is configured to execute operations on one or more hardware and/or software modules, such as Network Interface Cards (NICs), hard disks, virtualization layers, firewalls and/or the like. Examples of the operating system 210 may include, but are not limited to, various versions of LINUX, MAC OSX, BSD, UNIX, MICROSOFT WINDOWS, 10S, ANDROID and the like. In some embodiments, operating system 210 may include an application programming interface (API) which can be used to access and user device information and features.

Device A 202 and Device B 203 further include Physically Unclonable Functions, PUFA 220A and PUFB 220B, respectively. The PUFs produce a unique value (i.e., a digital identity/fingerprint) based on the physical device microstructure as described above. The unique PUF value is derived each time it is necessary to use it, and is not stored in memory after each use.

Device A 202 and Device B 203 include, or are further connected to, error correction modules 220 and key generation modules 222. In some embodiments, each device may include the modules 220 and 222 in their memory 208. In other embodiments, one or more of modules 220 and 222 are located on separate systems that are communicatively coupled to devices 202 and 203. The key generation module 224 is used to both generate public and private keys for each device, as well as derive sessions keys, and encrypt/decrypt messages. In some embodiments, the key generation module 224 may be comprised of a collection of multiple components or modules. For example, the key generation module 224 may include a public key pair generator configured to create a PUF key pair including a public key and a secret key that are generated based on the PUF value, a session key generator configured to derive a first session key using the PUF key pair and PUF value, an extropy extractor configured to derive a random value intrinsic to the first device, and the like.

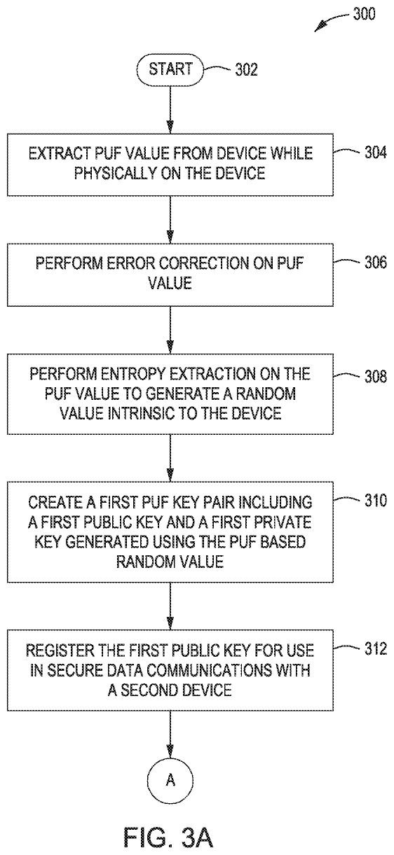

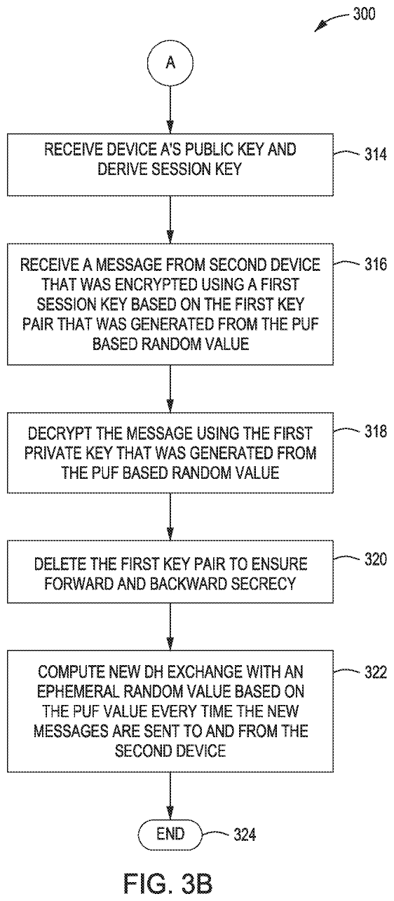

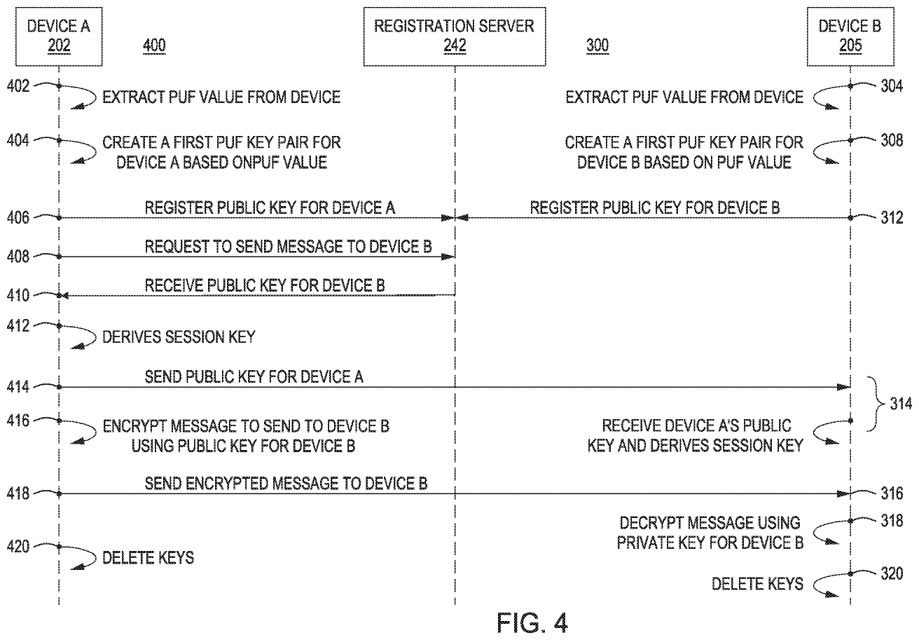

Exemplary methods that may be performed by one or more elements of system 200 ensuring forward and backward secrecy using PUFs are described below with respect to FIGS. 3A, 3B and 4. FIGS. 3A and 3B are a flow diagram of an exemplary method 300 for ensuring forward and backward secrecy using PUFs from the perspective of the recipient device, in this example device B 203. FIG. 4 is a signal diagram depicting the signaling and processing of sending device A 202, recipient device B 203, and server 242.

The method 300 starts at 302 and proceeds to 304 where the key registration phase begins. At 304, a unique PUF_{B} value is extracted from Device B 203 using PUF_{B} 220B. The PUF_{B} 220B may employ Weak-PUF (W-PUF) or Strong-PUF (S-PUF) as described above. In some embodiments, the PUF value may be based on an applied stimulus to the device. Once the PUF_{B} value is extracted for device 203, error correction is performed at 306 by error correction module 222. The error correction module removes the “noise” from the PUF value such that the same unique digital fingerprint is obtained for the device the PUF value is being extracted from, and can be reproduced every time it is requested.

At 308, the PUF output is used as a “seed” to derive a random value intrinsic to the device (e.g., device 203) by the key generation module 224. This is typically done using a randomness extractor (also referred to as an entropy extraction), which is a function applied to output from a weakly random entropy source together with a short, uniformly random seed, that generates a highly random output that appears independent from the source and uniformly distributed. In some embodiments, entropy extraction may be performed on the PUF value using a hash function.

At 310, the PUF key pair for device B 203 is created using the random value output at step 308 by the key generation module 224. The PUF key pair includes a first public key and a first private key for device B 203. In some embodiments, the PUF value, or rather the expanded random value generated using the PUF value, is converted to a secret point on an elliptic curve to generate the secret key ϕsk. In some embodiments, the curve may be Curve25519 which is known in the area of cryptology as an elliptic curve offering 128 bits of security and designed for use with the elliptic curve Diffie-Hellman (ECDH) key agreement scheme. Then the corresponding public key ϕpk is created. The value of ϕ is never stored in memory; it is only calculated when required. At 312, the public key ϕpk is registered with key registration module 214 on server 242 for public dissemination as needed.

After the key registration phase is completed in 304 through 312, the key setup phase is performed at 314. At 314, device B 203 receives device A's 202 public key. The key generation module 224 of device B then derives the session key using key derivation functions and device A's 202 public key, as well as other information such as an ephemeral key, device A's long-term identity key, and other keys. The key derivation functions include the use of Diffie-Hellman algorithms to derive the session keys.

At 316, device B 203 receives a message from device A 202 that was encrypted using the session key based on the PUF key pair that was generated from the PUF based random value as described above. At 318, device B 203 is then able to decrypt the message using its own session key generated similarly such that what is a private key for device A is a public key for device B and vice versa. In some embodiments, key generation module 224 may be used to decrypt the message. After the message is decrypted, the PUF derived key pair of device B (both public ϕpk and private ϕsk) is deleted at 320 to ensure forward and backward secrecy of messages sent and messages to be sent.

At 322, a double ratcheting algorithm is employed such that a new Diffie-Hellman exchange with an ephemeral random value based on the PUF value is computed every time the new messages are sent to and from the second device. In cryptography, the Double Ratchet Algorithm is a key management algorithm that can be used as part of a cryptographic protocol to provide end-to-end encryption for messaging. After an initial key exchange, the algorithm manages the ongoing renewal and maintenance of short-lived session keys. It combines a cryptographic ratchet based on the Diffie-Hellman key exchange (DH) and a ratchet based on a key derivation function (KDF) like a hash function and is therefore called a double ratchet. Essentially, once the keys have been set up, forward secrecy is achieved by computing a new DH exchange with an ephemeral random value every time device A replies to device B (and vice-versa). If device A wants to send device B a second message before device B replies to device A's first message, device A performs a symmetric Key Derivation Function (KDF) (the same applies to B messaging A). This allows multiple messages to be sent in the case that B is offline or not responding. If at some point in the future there is a key leak, adversarial eavesdropper E won't be able to decrypt past communications, only the current ratchet block. Without a PUF, E will be able to spoof future conversations via a MITM attack if the root and identity keys are leaked. Thus, as employed above, the keys evolve such that every time the system needs to send a message, the information is recreated starting from extracting the unique PUF value from PUF 220, reconstructing the public and secret keys, incorporate this information into refreshing the session keys, and then delete the keys that were created. Therefore, all the previous keys are protected because they evolved over time. Similarly, all future keys are protected because even if the current key is known, an adversarial party will need to physically read/extract the PUF value from the physical device itself in order to create the next key.

FIG. 4 depicts a signal diagram of methods and systems for ensuring forward and backward secrecy using PUF in accordance with embodiments of the present principles. The diagram includes the method 300 performed on device B 203. In addition, the diagram shows the signaling between sending device A 202, recipient device B 203, and server 242. The method 400 is described below with respect to FIG. 4.

Elements 402-406 of method 400 correspond to elements 304-312 described above with respect to method 300 and are similarly performed on/by device A 202. After the key registration phase is completed at 406, device A 202 may request to send a message to device B 203 at 408. The request is received by server 242 which then sends device B's public key information to device A. At 410, device A receives device B's public key information, and key generation module 224 on device A derives a session key at 412 using device B's public key information as well as potential other information as described above.

At 414, device A sends its public key (i.e., device A's public key) to device B. At 416, device A encrypts the message it wants to send to device B using the session key generated as described above, among other information. At 418, device A sends the encrypted message to device B, and then deletes the keys at 420.

The methods and systems described above advantageously provides the following benefits:
Even if all the keys are leaked, E can only eavesdrop on one session only.
Future messages are protected by requiring physical access to the device PUF to perform the DH algorithm (backward secrecy).
A MITM attack is also prevented, as A can verify that the DH was performed on the B's physical device.
Trusted central server still not required as it can never see the contents of the messages.
No secret PUF information ever leaves the device.
Only device B can decrypt messages, i.e. messages are linked to the physical devices themselves.
The DH ratchet incorporating the PUF could be updated hourly, daily or weekly as required.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

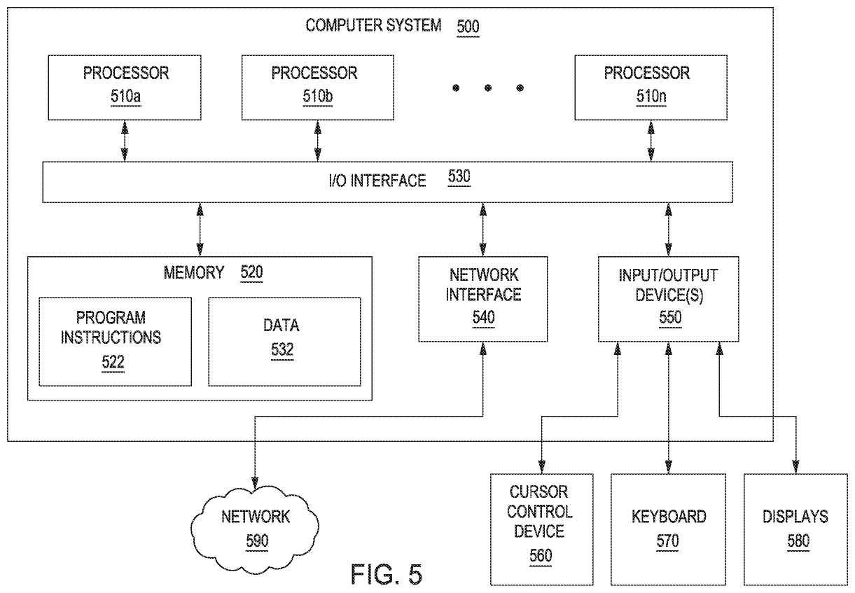

FIG. 5 depicts a computer system 500 that can be utilized in various embodiments of the present invention to implement the computer and/or the display, according to one or more embodiments.

Various embodiments of method and apparatus for ensuring forward and backward secrecy using PUF, as described herein, may be executed on one or more computer systems, which may interact with various other devices. One such computer system is computer system 500 illustrated by FIG. 5, which may in various embodiments implement any of the elements or functionality illustrated in FIGS. 1-4. In various embodiments, computer system 500 may be configured to implement methods described above. The computer system 500 may be used to implement any other system, device, element, functionality or method of the above-described embodiments. In the illustrated embodiments, computer system 500 may be configured to implement the methods 300 and 400 as processor-executable executable program instructions 522 (e.g., program instructions executable by processor(s) 510) in various embodiments.

In the illustrated embodiment, computer system 500 includes one or more processors 510a-510n coupled to a system memory 520 via an input/output (I/O) interface 530. Computer system 500 further includes a network interface 540 coupled to I/O interface 530, and one or more input/output devices 550, such as cursor control device 560, keyboard 570, and display(s) 580. In various embodiments, any of the components may be utilized by the system to receive user input described above. In various embodiments, a user interface may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510 may be any suitable processor capable of executing instructions. For example, in various embodiments processors 510 may be general-purpose or embedded processors implementing any of a variety of instruction set architectures (ISAs). In multiprocessor systems, each of processors 510 may commonly, but not necessarily, implement the same ISA.

System memory 520 may be configured to store program instructions 522 and/or data 532 accessible by processor 510. In various embodiments, system memory 520 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via digital fiber communications networks; via storage area networks such as Fiber Channel SANs, or via any other suitable type of network and/or protocol.

Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the operations and methods described above, such as the methods illustrated by the flowchart of FIGS. 3A-6. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine (e.g., a computing device or a “virtual machine” running on one or more computing devices). For example, a machine-readable medium may include any suitable form of volatile or non-volatile memory.

Modules, data structures, and the like defined herein are defined as such for ease of discussion and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure.

This disclosure is to be considered as exemplary and not restrictive in character, and all changes and modifications that come within the guidelines of the disclosure are desired to be protected.

1. A method for ensuring forward and backward secrecy in an encrypted communication protocol, the method comprising:
extracting, from a first device, a unique physically unclonable function (PUF) value of the first device based on structural properties of the first device;
creating a PUF key pair including a first public key and a first private key that are generated based on the PUF value;
deriving a first session key using the PUF key pair;
deleting the first public key and the first private key; and
sending a first encrypted communication to a second device using the derived session key.

2. The method of claim 1, the method further comprising sending a second encrypted communication to the second device, wherein sending the second encrypted communication includes:
extracting, from the first device, the unique PUF value of the first device based on structural properties of the first device;
creating a second PUF key pair including a second public key and a second private key based on the PUF value;
refreshing the session key using the second PUF key pair and PUF value;
deleting the second public key and the second private key; and
using the refreshed session key to send the second encrypted communication to the second device.

3. The method of claim 1, wherein one or more error correction algorithms are used on the PUF value to ensure that the same unique value is produced each time the PUF value is obtained.

4. The method of claim 1, wherein the PUF value is obtained using a Weak-PUF implementation.

5. The method of claim 1, wherein the PUF value is obtained using a Strong-PUF implementation that generates a unique response to different challenges.

6. The method of claim 1, wherein sending encrypted communications between the first and second devices comprises using a double ratchet algorithm that uses a new session key for every new communication between the first and second devices.

7. The method of claim 1, wherein the extracted PUF value is used as input to generate a random number that is used to create the PUF key pair.

8. The method of claim 1, wherein the extracted PUF value is converted to a point on a curve via an entropy extractor followed by a point conversion algorithm to generate a secret key.

9. The method of claim 1, wherein the extracted PUF value is never stored in memory and is only extracted when required.

10. The method of claim 1, further comprising:
registering the first public key with a key registration server accessible by the second device.

11. The method of claim 1, wherein deriving the first session key using the PUF key pair further includes:
receiving the second device's public key; and
deriving the first session key using the second device's public key.

12. The method of claim 11, wherein key derivation functions are used to derive the first session key, and wherein the key derivation functions include the use of Diffie-Hellman algorithms to derive the first session key.

13. The method of claim 11, wherein the method further includes:
receiving a second encrypted communication from the second device that was encrypted using the first session key; and
decrypting the second encrypted communication using the first private key.

14. A system for ensuring forward and backward secrecy in an encrypted communication protocol, the system comprising:
a first device having a unique physically unclonable function (PUF) value based on structural properties of the first device;
a public key pair generator configured to create a PUF key pair including a public key and a secret key that are generated based on the PUF value;
a session key generator configured to derive a first session key using the PUF key pair and PUF value; and
a secure communication module configured to send a first encrypted communication to a second device using the derived session key.

15. The system of claim 14, further comprising:
an error correction module configured to remove noise from the PUF value such that a same unique digital fingerprint is obtained for the first device each time it is extracted.

16. The system of claim 14, further comprising:
an extropy extractor configured to derive a random value intrinsic to the first device.

17. A non-transitory computer-readable storage device having stored thereon a plurality of instructions, the plurality of instructions including instructions which, when executed by a processor, cause the processor to perform a method for ensuring forward and backward secrecy in an encrypted communication protocol, comprising:
extracting, from a first device, a unique physically unclonable function (PUF) value of the first device based on structural properties of the first device;
creating a PUF key pair including a first public key and a first private key that are generated based on the PUF value;
deriving a first session key using the PUF key pair;
deleting the first public key and the first private key; and
sending a first encrypted communication to a second device using the derived session key.

18. The non-transitory computer-readable storage device of claim 17, wherein the method further comprising sending a second encrypted communication to the second device, wherein sending the second encrypted communication includes:
extracting, from the first device, the unique PUF value of the first device based on structural properties of the first device;
creating a second PUF key pair including a second public key and a second private key based on the PUF value;
refreshing the session key using the second PUF key pair and PUF value;
deleting the second public key and the second private key; and
using the refreshed session key to send the second encrypted communication to the second device.

19. The non-transitory computer-readable storage device of claim 17, wherein one or more error correction algorithms are used on the PUF value to ensure that the same unique value is produced each time the PUF value is obtained.

20. The non-transitory computer-readable storage device of claim 17, wherein sending encrypted communications between the first and second devices comprises using a double ratchet algorithm that uses a new session key for every new communication between the first and second devices.
